(19) United States
(12) Patent Application Publication
(10) Pub. No.: US 2017/0029909 A1
(43) Pub. Date: Feb. 2, 2017

(54) TANNING OF SUBSTRATES USING IONIC LIQUIDS

(71) Applicants: UNIVERSITY OF LEICESTER, Leicester (GB); UNIVERSITY OF NORTHAMPTON, Northamton (GB)

(72) Inventors: Andrew Peter Abbott, Leicester (GB); Jeffry Guthrie-Strachan, Northampton (GB); William Wise, Leicester (GB)

(21) Appl. No.: 15/304,385

(22) PCT Filed: Apr. 14, 2015
(86) PCT No.: PCT/GB2015/051134

§ 371 Date: Oct. 14, 2016

(30) Foreign Application Priority Data
Apr. 14, 2014 (GB) 1406651.8

(51) Int. Cl. C14C 3/10; C14C 3/06; C14C 9/00; D06P 3/00

(52) U.S. Cl. CPC C14C 3/10; D06P 3/008; C14C 3/06; C14C 9/00

(57) ABSTRACT

The invention provides a process for tanning a substrate using at least one ionic liquid. The at least one ionic liquid can be used in at least one of the following tanning steps: tanning, re-tanning, preservation, liming, pickling, impregnation, lubrication, dyeing, fatliquoring or finishing.

This invention relates to the application of ionic liquids to the processing of substrates, and in particular, to leather manufacture.

The production of leather is an activity with a history of over 6000 years. Leather is a durable, flexible material created by the tanning of animal rawhide and skin. Typically cattle hide is used, although fish skin can also be used to make fish leather. Other animals such as lamb, deer, pig, buffalo, goats, alligators, snakes, ostriches, kangaroos, oxen and yaks have been used for leather.

Modern leather manufacture typically involves four stages that include machinery operations interspersed within and between stages (Covington AD, 2009, Tanning Chemistry. The science of leather):

Firstly, the preparatory steps in the production of leather are called Beamhouse operations which involve liming, deliming and bating. These are steps designed to remove all or some of the unwanted components of the hides and skins and prepare the collagenic protein for tanning. The processes are:
(i) removal of hair using a reducing agent and opening up or splitting of the fibre structure by liming i.e. the controlled hydrolysis of the hide protein and cutaneous fats at high pH using hydrated lime (Ca(OH)₂);
(ii) de-swelling of the swollen structure by lowering the pH and removal of hydrolysed material; and
(iii) continuing protein breakdown using proteolytic enzymes.

Once bating is complete, the next preparatory steps involve pickling and tanning. These processes are carried out in order to:
(i) prepare the material for tanning using acid in brine; and
(ii) stabilise the collagen structure against bacterial degradation using tanning agents (typically using a metal salt such as basic chromium (III) sulfate salt, or a polyphenol).

The pickling and tanning steps crosslink the collagen and prevent putrefaction of the hide.

Following on from tanning, the next step is post tanning which includes re-tanning, dyeing and fatliquoring to add additional tanning agents, colouring agents and lubricating chemicals to provide the appropriate physical and tactile properties required of the leather. In particular, the re-tanning step is used to shrink the hide and the fatliquoring step is used to get oils into the hide to make it more flexible.

Finally, a finishing step is required which includes techniques such as spraying, padding and rollercoating in order to apply polymeric surface coating formulations to the leather to achieve the final fashion, colour and feel properties required by the customer.

Leather is essentially a proteinaceous polyelectrolyte material processed in aqueous solution, where the ionic groups of the protein control the chemical properties and can be manipulated by changes in pH. Typically, the manufacturing process takes several days to complete and may involve the use of up to 50 m³ of water and 500 kg of active ingredients per tonne of raw material processed (see the European Commission Industrial Emissions Directive, Industrial Pollution Prevention and Control (IPPC), 2013).

Leather is a product with some environmental impact. Throughout history, the manufacture of leather has been characterised by the volume of aqueous and solid waste produced. This remains a matter of concern to leather producers, even today.

Surprisingly, we have now found that ionic liquids can be used in leather manufacture. The ionic liquids which can be used in the present invention are described, for example, in WO 00/56700, WO 02/26381, WO 02/26701, WO 2007/003956 and W02011/064556.

According to the present invention there is provided a process for tanning a substrate using at least one ionic liquid.

Preferably, the substrate is selected from a collagenic biomaterial or a textile material.

Optionally, the collagenic biomaterial is selected from animal hides, skins, tendon, ligament and cartilage.

Conveniently, the at least one ionic liquid is used in at least one of the following steps:
(i) tanning;
(ii) re-tanning;
(iii) preservation;
(iv) liming;
(v) pickling;
(vi) impregnation;
(vii) lubrication;
(viii) dyeing;
(ix) fatliquoring; or
(x) finishing.

Preferably, wherein at least one of the steps further comprises using reagents which confer desired properties to the substrate and which are incorporated into the ionic liquids as solutes or as components of the ionic liquids themselves.

Optionally, wherein the reagents are selected from graphite, elemental sulphur, metal and semi-metal oxides, inorganic complexes and inorganic complex salts, organic polymers and reactive organic oligomers, Type II Eutectics and Type IV Eutectics.

Conveniently, wherein at least one of the steps is performed in a substantially non-aqueous system. As used herein, the skilled person would understand the term “substantially non-aqueous” to mean less than 10% water is present in the system, preferably less than 5%, more preferably less than 1%, and even more preferably less than 0.1%.

Preferably, the ionic liquid is in the form of a liquid formulation which is sprayed onto the substrate, preferably wherein the ionic liquid is in the form of a gel.

Optionally, in the dyeing step, the ionic liquids are used to dissolve reactive dyes, preferably wherein the reactive dye is selected from dichlorotriazine or dichloroquinoxaline.

Conveniently, the ionic liquid is selected from Deep Eutectic solvents, non-reactive ionic liquids with discrete anions and ionic liquids with Brönsted acidic cations.

Preferably, wherein the Deep Eutectic solvent is selected from at least one of the following:
(i) metal salt+organic salt
(ii) metal salt hydrate+organic salt
(iii) organic salt+hydrogen bond donor
(iv) metal salt hydrate+hydrogen bond donor.

Optionally, wherein the Deep Eutectic solvent is a mixture having a freezing point of up to 50° C., formed by reaction between:
(A) one molar equivalent of a salt of formula (I)

(Mⁿ⁺)(X⁻)ₙ (I)
or a hydrate thereof;
wherein
   M represents one or more metallic elements selected from the group consisting of Mg, Ca, Cr, Mn, Fe, Co, Ni, Cu, Zn, Ga, Ge, In, Sn, TI, Pb, Cd, Hg and Y,
X⁻ is one or more monovalent anions selected from the group consisting of halide, nitrate and acetate and
n represents 2 or 3; and
(B) from one to eight molar equivalents of a complexing agent comprising one or more uncharged organic compounds, each of which compounds has
(i) a hydrogen atom that is capable of forming a hydrogen bond with the anion X⁻; and
(ii) a heteroatom selected from the group consisting of O, S, N and P that is capable of forming a coordinative bond with the metal ion Mⁿ⁺,
which reaction is performed in the absence of extraneous solvent.

Conveniently, wherein the anion X⁻ is an anion selected from the group consisting of chloride, nitrate and acetate.

Preferably, wherein the complexing agent (component (B)) consists of one or more organic compounds, each of which compounds has
(i) A hydrogen atom that is capable of forming a hydrogen bond with the anion X⁻; and
(ii) An oxygen atom that is capable of forming a co-ordinative bond with the metal ion Mⁿ⁺.

Optionally, the complexing agent consists of one or more compounds of formula II and/or formula III,

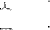

wherein
R¹ represents H, C₁₋₄ alkyl (which latter group is optionally substituted by one or more F atoms), or N(R²)R³;
R² and R³ independently represent H or C₁₋₄ alkyl (which latter group is optionally substituted by one or more F atoms);
A represents C₂₋₁₀ alkylene optionally
(i) substituted by one or more substituents selected from F, OH, SH and N(R⁴)R⁵, and/or
(ii) interrupted by one or more groups selected from O, S and NR⁶; and
R⁴ to R⁶ independently represent H or C₁₋₄ alkyl (which latter group is optionally substituted by one or more substituents selected from F and OH);
provided that the compound of formula (III) does not contain any C-atoms that are bonded to more than one atom selected from the group O, S and N.

Conveniently, wherein the complexing agent is acetamide, urea, ethylene glycol, 1,3-propanediol, 1,4-butanediol, 1,5-pentanediol, 1,6-hexanediol or glycerol.

Preferably, the Deep Eutectic solvent is a mixture and is selected from:
(i) CrCl₃.6(H₂O)+2(urea); and
(ii) 1 Kr(SO₄)₂.10H₂O: 1 glycerol.

In accordance with a further aspect of the present invention there is provided a leather or textile obtainable using a process described herein.

In a further aspect of the present invention there is provided the use of ionic liquids in tanning processes. In accordance with a further aspect of the present invention, there is provided the use of ionic liquids in leather manufacturing.

Ionic liquids constitute a class of chemical species which can be described in many ways (see, for example, Abbot et al. What is an ionic liquid? Application of Hole theory to define ionic liquids by their transport properties. J Phys. Chem B, 111: 4910-4, 2007), in which it has been suggested that most ionic systems can be described by an equilibrium:

cation+anion+complexing agent [symbol] cation+complex anion

or potentially:

cation+anion+complexing agent [symbol] complex cation+anion

with the majority falling under the category of the former case. This also applies to some ionic liquids that are thought of as having a discrete anion, for example:

Cat⁺+F⁻+BF₃ [symbol] Cat⁺+BF₄⁻

The equilibrium is simple and lies far to the right of the equation with negligible F⁻ in a dry environment. As the strength of the complexing agent decreases, a variety of complex anions are possible. Hence the well-known chloroaluminate system, which was probably the first well studied ionic liquid, can be described by:

2 CatCl+3 AlCl₃ [symbol] 2 Cat⁺+AlCl₄⁻+Al₂Cl₇⁻

Other metal halides such as ZnCl₂ and SnCl₂ form similar complexes (see, for example, Abbott et al. Preparation and applications of novel ionic liquids based on metal chloride/substituted quaternary ammonium salt mixtures. Inorg. Chem., 43: 3447, 2004).

Type III Deep Eutectic Solvents are types of ionic liquids which do not include metallic species in the bulk liquid but use a hydrogen bond donor (HBD), such as urea or ethylene glycol to complex the anion from the salt (see, for example, Abbott et al. Novel solvent properties of choline chloride/urea mixtures. Chem. Comm., 70, 2003; and Abbott et a/. Deep Eutectic solvents formed between choline chloride and carboxylic acids, J. Am. Chem. Soc., 26: 9142, 2004).

Cat⁺Cl⁻+HBD [symbol] Cat⁺+Cl⁻·HBD

Others have even proposed that a conventional inorganic salt with a small concentration of water produces a liquid with properties akin to an ionic liquid (see, for example, Xu W et al., Solvent-free electrolytes with aqueous solution-like conductivities. Science, 2003 422-425). For example:

LiClO₄+3.5H₂O [symbol] Li⁺.xH₂O+ClO₄⁻.yH₂O

This idea has recently been extended to include metal salts with complexants such as acetonitrile, MeCN (see, for example, Schaltin et al., High current density electrodeposition from silver complex ionic liquids. J. Phy Chem. Chem. Phys., 14: 17061715, 2012). For example:

AgTf₂N+MeCN [symbol] Ag⁺.MeCN+Tf₂N⁻

Surprisingly, metal salts such as AlCl₃ and ZnCl₂ have been found to disproportionate to give both anionic and cationic metal containing species (see, for example, Abood et al, Do all ionic liquids need organic cations? Chem. Comm., 47: 3523-35-27). See, for example:

2AlCl₃+nAmide [symbol] [AlCl₂·nAmide]⁺⇄AlCl₄⁻

Additionally metal hydrate salts can be used with HBDs to formulate active ingredients. For example:

CrCl₃.x(H₂O)+y(HBD) [symbol] CrCl₂⁺.x(H₂O).y(HBD)+Cl⁻.H₂O.

Surprisingly, the applicants have found the principle of incorporating reagents into ionic liquids, either as solutes or as components of the ionic liquids themselves. These liquids can then be used for application to solid substrates in selective degradation or fixation heterogeneous reactions.

Such substrates include, but are not limited to collagenic biomaterials and other textile materials. Sources of collagenic biomaterials include skin, tendon, ligament and cartilage.

The ionic liquids can be used to improve reactions, for example to make better or novel leathers. Additionally, they can be used to dye/colour substrates more efficiently and effectively.

In an embodiment of the present invention, animal hides or skins are processed using largely ionic systems in an extensively non-aqueous system. Highly ionic liquids replace the water in the essential process steps required to make leather. It is recognised that hide may be extensively wet when it comes into contact with the ionic liquid and so the process may not be completely anhydrous, however, the ionic character of these liquids should exceed the molecular character.

It is also acknowledged that some of the salts necessary for tanning, for example, may be metal salt hydrates, e.g., CrCl₃.6H₂O, contributing to the water content of the reaction medium. The present invention is not concerned with new ionic liquids per se but rather their novel application to the processing of leather. The general requirement for the ionic liquids is that they will be low-cost and non-toxic.

In accordance with one aspect of the present invention, the type of ionic liquid used in leather or textile processing is a Deep Eutectic solvent. These are ionic liquids which may be formed by mixing a neutral organic molecule such as urea with a metal salt that is weakly ionic and/or that contains a multiply-charged metal ion.

In one embodiment, the Deep Eutectic solvent is a mixture having a freezing point of up to 50° C., formed by reaction between:

(A) one molar equivalent of a salt of formula (I)

(Mⁿ⁺)(X⁻)ₙ (I)
or a hydrate thereof;
wherein
M represents one or more metallic elements selected from the group consisting of Mg, Ca, Cr, Mn, Fe, Co, Ni, Cu, Zn, Ga, Ge, In, Sn, TI, Pb, Cd, Hg and Y,
X⁻ is one or more monovalent anions selected from the group consisting of halide, nitrate and acetate and
n represents 2 or 3; and

(B) from one to eight molar equivalents of a complexing agent comprising one or more uncharged organic compounds, each of which compounds has
(i) a hydrogen atom that is capable of forming a hydrogen bond with the anion X⁻; and
(ii) a heteroatom selected from the group consisting of O, S, N and P that is capable of forming a coordinative bond with the metal ion Mⁿ⁺,
   which reaction is performed in the absence of extraneous solvent,

The term “uncharged”, when used herein in relation to complexing agents, refers to organic molecules (compounds) that do not bear a permanent positive or negative (electrostatic) charge on any atom within the molecule. In this respect, uncharged organic compounds are those that comprise a single, covalently-bonded molecule and that are not separated into cationic and anionic components.

When used herein, the term “extraneous solvent” refers to an inorganic or organic solvent system that is other than the essential complexing agent (component (B)) or the water molecules that may be present in hydrates of the salt of formula I.

The freezing point of the mixture, as mentioned above, is up to 50° C., but may, in certain embodiments of the invention, be up to 45, 40, 35, 30 or, particularly, 25, 20, 15 or 10° C. (for example from −35 or, particularly, −30° C. to any of the above-mentioned upper limits). In this respect, the freezing point of a mixture is defined as the temperature at which solidification is first observable when the mixture is allowed to cool from a higher temperature.

Hydrates of the salt of formula I that may be mentioned include:

(i) monohydrates of CaX₂ (e.g. CaCl₂, Ca(OAc)₂ or Ca(NO₃)₂);

(i) dihydrates of CaX₂ (e.g. CaCl₂), MnX₂ (e.g. Mn(OAc)₂), CuX₂ (e.g. CuCl₂), ZnX₂ (e.g. Zn(OAc)₂), CdX₂ (e.g. Cd(OAc)₂) and SnX₂ (e.g. SnCl₂);

(ii) trihydrates of CuX₂ (e.g. Cu(NO₃)₂) and PbX₂ (e.g. Pb(OAc)₂);

(iii) tetrahydrates of MgX₂ (e.g. Mg(OAc)₂), CaX₂ (e.g. Ca(NO₃)₂), MnX₂ (e.g. MnCl₂ or Mn(NO₃)₂), FeX₂ (e.g. FeCl₂), NiX₂ (e.g. Ni(OAc)₂), ZnX₂ (e.g. Zn(NO₃)₂) and CdX₂ (e.g. Cd(NO₃)₂);

(iv) hexahydrates of MgX₂ (e.g. MgCl₂ or Mg(NO₃)₂), CaX₂ (e.g. CaCl₂), CrX₃ (e.g. CrCl₃), FeX₃ (e.g. FeCl₃), CoX₂ (e.g. CoCl₂ or Co(NO₃)₂) and NiX₂ (e.g. NiCl₂ or Ni(NO₃)₂); and

(v) hydrates of Cr(NO₃)₃ and Fe(NO₃)₃.

(vi) alums of the form AM^{III}(SO₄)₂.nH₂O which may include KCr(SO₄)₂.12(H₂O), NH₄Al(SO₄)₂.12H₂O.

In one embodiment of the invention, M represents more than one (e.g. two) metallic elements selected from the list at (A) above. Alternatively, M represents one or more (e.g. two, or in a particular embodiment, one) metallic elements selected from the group consisting of Cr, Mn, Fe, Co, Ni, Cu, Zn and Sn (e.g. Cr, Fe, Ni, Zn and Sn or, particularly, Cr, Zn and Sn).

In an alternative embodiment of the invention, M represents one or more (e.g. one) metallic elements selected from Mg and Ca. In this embodiment of the invention, the salt of formula (I) is preferably provided as a hydrate (e.g. a hexahydrate).

When the salt of formula (I) is anhydrous, the melting point of that salt is, in a particular embodiment, 400° C. or less (e.g. from 75 to 400° C., such as from 100 to 350° C.).

When the salt of formula I is in the form of a hydrate, the melting point of that salt is, in a particular embodiment, 100° C. or less (e.g. from 40 to 100° C.).

In a particular embodiment of the invention, the anion X⁻ is one or more (e.g. one) anions selected from the group consisting of chloride, nitrate and acetate (e.g. chloride and nitrate).

The complexing agent (component (B)), in one embodiment of the invention, consists of one or more uncharged organic compounds, each of which compounds has

(i) a hydrogen atom that is capable of forming a hydrogen bond with the anion X⁻; and

(ii) a heteroatom selected from the group consisting of O, S and N (e.g. an O atom) that is capable of forming a coordinative bond with the metal ion Mⁿ⁺.

In this respect, and in another particular embodiment of the invention, the complexing agent consists of one or more compounds (e.g. one compound) of formula (II) and/or formula (III),

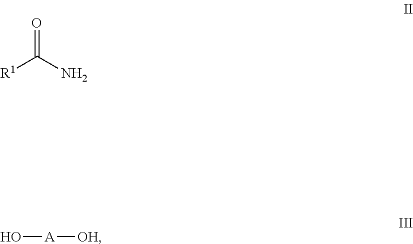

wherein

R¹ represents H, C₁₋₄ alkyl (which latter group is optionally substituted by one or more F atoms), or N(R²)R³;

R² and R³ independently represent H or C₁₋₄ alkyl (which latter group is optionally substituted by one or more F atoms);

A represents C₂₋₁₀ alkylene optionally
(i) substituted by one or more substituents selected from F, OH, SH and N(R⁴)R⁵, and/or
(ii) interrupted by one or more groups selected from O, S and NR⁶; and

R⁴ to R⁶ independently represent H or C₁₋₄ alkyl (which latter group is optionally substituted by one or more substituents selected from F and OH);

provided that the compound of formula (III) does not contain any C-atoms that are bonded to more than one atom selected from the group O, S and N.

Unless otherwise specified, alkyl groups as defined herein may be straight-chain or, when there is a sufficient number (i.e. a minimum of three) of carbon atoms be branched-chain, and/or cyclic. Further, when there is a sufficient number (i.e. a minimum of four) of carbon atoms, such alkyl and alkoxy groups may also be part cyclic/acyclic.

Further, unless otherwise specified, alkylene groups as defined herein may be straight-chain or, when there is a sufficient number (i.e. a minimum of two) of carbon atoms, be branched-chain.

Compounds of formula (II) that may be mentioned include those in which R¹ represents H, CH₃, CF₃, NH₂, N(H)CH₃ or N(CH₃)₂. In this respect, particular compounds of formula (II) that may be mentioned include acetamide and urea.

Compounds of formula (III) that may be mentioned include those in which A represents C₂₋₆ n alkylene or C₃₋₄ alkylene substituted by one or two OH groups. In this respect, particular compounds of formula III that may be mentioned include 1,2-ethanediol (ethylene glycol), 1,3-propanediol, 1,4-butanediol, 1,5-pentanediol, 1,6-hexanediol and 1,2,3-propanetriol (i.e. glycerol).

Other embodiments of the invention that may be mentioned include those in which each of the one or more compounds of the complexing agent (component (B)) has:

(i) a melting point greater than −20° C. (e.g. from −20 to 200, 180, 160 or, particularly, 140° C.);

(ii) a molecular weight of less than 200 g/mol (e.g. from 45 to 200, 180, 160, 140 or, particularly, 120 g/mol); and/or

(iii) if liquid at a temperature of 25° C., a viscosity at that temperature (as determined, for example, by measuring by torque resistance to an immersed spindle running at constant speed) and in the pure state of greater than 50 centipoise (cP) (e.g. from 50 to 30,000 cP).

The Eutectic mixture of the invention may be prepared by mixing the metal salt of formula (I) (component (A)) with the complexing agent (component (B)). In order to facilitate preparation of the mixture, the components (A) and (B) may be heated together at elevated temperature, such as any temperature from 35 to 200° C. (e.g. from 60 to 100° C., such as 80° C.).

As stated above, the Eutectic mixture of the invention contains one molar equivalent of the metal salt of formula (I) (component (A)) and from one to eight molar equivalents of the complexing agent (component (B)). However, in a particular embodiment of the invention, the molar ratio of component (A) to component (B) is any value in the range from 2:3 to 1:7 (e.g. any value in the range from 1:2 to 1:5).

In a particular embodiment, the Eutectic mixture of the invention, if liquid at 25° C., has a viscosity at that temperature (as determined by measuring by torque resistance to an immersed spindle running at constant speed) of below 15,000 cP (e.g. below 12,000, 10,000, 8,000, 6,000, 4,000 or, particularly, 2000 cP, such as in the range from 25, 50 or 100 cP to any of the above-mentioned upper limits). When component (B) is an amide (e.g. acetamide), a particular embodiment relates to a mixture of the invention in which, if liquid at 25° C., the viscosity of the mixture at that temperature is below 1000 cP (e.g. below 500, 300, 200 or, particularly, 100 cP, such as in the range of 25 or 50 cP to any of the above-mentioned upper limits).

Other important properties of the mixture of the invention are surface tension and bulk density. In this respect, further embodiments relate to a mixture of the invention in which, if liquid at 25° C. has:

(a) a surface tension (as measured, for example, by using a ring or plate tensiometer) at 25° C. of any value in the range from 30 to 100 mN/m (e.g. any value in the range from 45 to 75 mN/m); and/or

(b) a bulk density at 25° C. of any value in the range from 1.25 to 1.75 g/cm³ (such as any value in the range from 1.35 to 1.65 g/cm³).

In accordance with the present invention, Deep Eutectic solvents, such as the mixtures described above are particularly useful for the application of leather tanning. They are advantageous because of their high solubility for polar compounds such as the vegetable tanning agents. Vegetable tanning agents come from various plants such as tree barks, wood, fruits, pods, leaves, roots and tubers.

Deep Eutectic solvents can also be formulated to contain metals such as chromium (III) which is the most commonly used tanning agent, e.g., Eutectic mixtures of 1 choline chloride: 2 CrCl₃.6H₂O. In one embodiment, the Eutectic mixtures used for tanning are comprised of metal salts or metal salt hydrates mixed with hydrogen bond donors, e.g., CrCl₃.6(H₂O)+2(urea) or 1 KCr(SO₄)₂.10H₂O: 1 glycerol.

Deep Eutectic solvents tend to be relatively viscous and their properties can be judiciously varied through choice of components. The ingress of species into leather is dominated by interfacial processes and the current aqueous solutions operate under relatively concentrated conditions to ensure that the species partition into the solid, largely ionic matrix.

In accordance with the present invention, ionic liquids other than Deep Eutectic solvents and Eutectic mixtures can be used in leather processing. Of particular note are non-reactive ionic liquids with discrete anions, e.g., alkyl imidazolium hexafluorophosphate; and ionic liquids with Brönsted acidic cations, e.g., trialkylammonium triflate. General examples of ionic liquids which can be used in the present invention are also shown below:

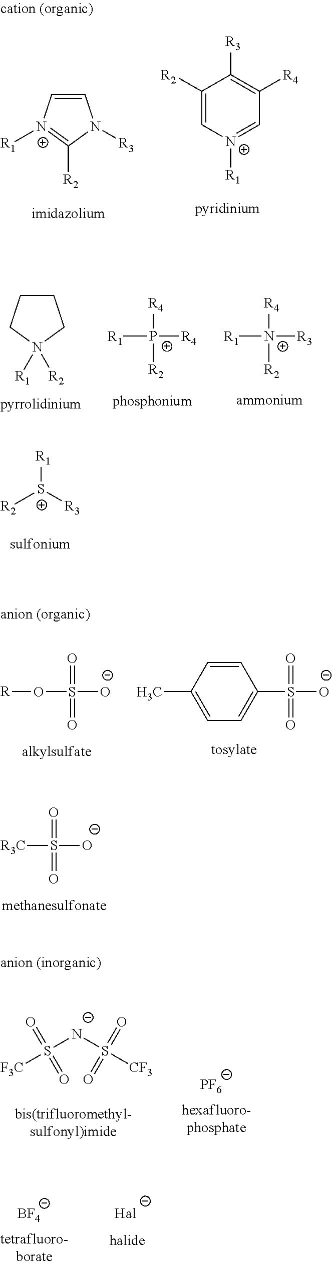

Since the reactions for making leather and other suchlike materials involve heterogeneous reactions, typically conventionally conducted in aqueous media, the fixation of reagents on the substrate is adversely affected by the equilibrium established between the substrate and the medium, the partitioning of the reagent between competing reactants, often limiting reaction efficiency and hence affecting the economics and environmental impact of the commercial operations.

Surprisingly, it has been observed that converting these conventional reactions to ionic liquid media can result in more rapid reaction and more efficient uptake of reagents, despite the lack of water in the system, which might be assumed by those familiar with the art to be essential.

Moreover, the nature of the properties of ionic liquids in general allows the formulation of delivery systems for a range of compounds for process steps which are inefficient or even impossible in aqueous media. In this way, new products for making leather become possible, to create new leathers or other biomaterials hitherto regarded by those skilled in the art as difficult or even impossible.

This is exemplified by the class of dyes referred to in the art as ‘reactive’, in which there is competition between the rates of the fixation reaction and hydrolysis in aqueous medium. Preferably, the reactive dyes are selected from dichlorotriazine or dichloroquinoxaline which react through hydroxyl groups on hydroxyproline, which is a major component of collagen.

Here, too, the reagents for delivery and fixation include but are not restricted to those which are relatively chemically inert, but which confer desired properties to the biomaterial in preparation, for example, graphite, elemental sulfur, metal and semi metal oxides and more reactive reagents such as inorganic complexes and inorganic complex salts.

In this context, delivery of reagents is not restricted to the internal structure of the substrate, but includes application of reagents to the surfaces of the substrate, referred to as ‘finishing’ in leather production. This is analogous to painting, and typically involves at least two layers, a base or undercoat and a topcoat, all of which might include added reagents to confer specific required properties to the treated surface. Such reagents include, but are not restricted to chemically inert materials, as described above, or inorganic salts or organic polymers or reactive organic oligomers.

In an embodiment, the inorganic salts/complexes which can be delivered include Type II and Type IV based Eutectics. Type II Eutectics include metal salt hydrate +organic salt (e.g. CoCl₂.6H₂O+choline chloride) and Type IV Eutectics include metal salt (hydrate) +hydrogen bond donor (e.g. ZnCl₂+urea). These types of Eutectics can include aluminium, iron, chromium and zinc salts so that they can be used as tanning agents. Examples include FeCl₃.6H₂O, KCr(SO₄)₂.10H₂O or KAl(SO₄)₂.12H₂O.

In a further embodiment, ionic liquids have been found to be particularly useful when involved in compact processing, when a single step includes one or more of the following operations:
(i) pickling the skin with Brönsted acidic ionic liquids;
(ii) tanning using metal salts or plant extracts (vegetable tanning agents);
(iii) retanning (where a wide range of chemical types is well known in the art);
(iv) dyeing (particularly for dyes that are insoluble in water); and
(v) lubrication of the fibres (fatliquoring).

The advantages of compact processing using this approach include:
(a) decrease in volume of fresh water used;
(b) decrease in waste water generated;
(c) decreased amounts of active ingredient used;
(d) the use of viscous liquid which allows the active ingredient to be applied as a gel;
(e) decreased processing times; and
(f) novel processes enabled, e.g., the suspension of colloidal particles in the leather structure.

In the traditional leather treatment process, the hide is ‘limed’ using Ca(OH)₂ for controlled hydrolysis of species in the substrate. The lime is conventionally and commonly removed by the application of ammonium salts (but this is increasingly falling out of favour because of environmental impact), but may also be removed from the treated hide using either an aqueous acid or using carbon dioxide.

In accordance with the present invention, the Beamhouse operations can be carried out using a mixture of choline chloride and oxalic acid, and the pH of the hide is regulated by the amount of liquid added. The latter point is important as the deliming step is typically followed by the application of proteolytic enzymes to degrade the non-structural proteins of the hide and this reaction is highly pH-specific.

Crystalline rock salt is often used as a preservative for animal hides before they are tanned. Up to a third of the hide's weight of salt is typically added to each hide to preserve it. The advantage of using ionic liquids in accordance with the present invention for preservation of hide is that a liquid formulation can be sprayed on the hide, decreasing the mass required and the cationic component or hydrogen bond donor could be substituted.

The primary function of the salt is to act as a bacteriostat, but an alternative approach is to use a bactericide to confer resistance to microbial degradation for the desired period of preservation (up to three months). Biocides commonly used in the leather industry include: didecyldimethylammonium chloride, 2-(cyanomethylthio)benzothiazole (TCMTB), methylene bis(thiocyanate (MBT), 1,2-benzisothiazolin-3-one (BIT), 1,3-dihydroxy-2-bromo-2nitropropane (bronopol). Insecticides to be incorporated may include 1-methyl-4-phenylpyridinium chloride, paraquat, diethamquat and cumyluron.

Fungicides may be used during soaking but are commonly used during tanning or post tanning operations to prevent the growth of moulds. Examples of common fungicides include: sodium dimethyldithiocarbamate, N-hydroxymethyl-N-methyldithiocarbamate, tetrahydro-3,5-dimethyl-2H-1,3,5-thiadiazine-2-thione, 2-thiocyanomethylthiobenzathiozole (TCMTB), berberine, sanguinarine, bentaluron and quinazamid.

The volume of aqueous waste that needs to be treated is an issue. There are numerous ionic liquids in accordance with the present invention that could be used to treat the hide as a gel. This will decrease the volume of liquid used and the amount of acid that needs to be neutralised. It also has a higher solubility for the calcium salts aiding their removal from the hide.

The step of dyeing of leather is traditionally carried out using a range of specialised water soluble dyes. Using ionic liquids in accordance with the present invention, as a medium to dissolve or suspend the dyes, increases the range of dyes that could be used. The high ionic strength and hydrophobicity of the ionic liquids allows a wider range of dyes to be solubilised.

The present invention also allows for the manufacture of speciality leathers in which chemical species are deposited within the fibre structure of the leather, for example, emulsions of polyethylene or elemental sulphur, as novel lubricating systems.

In accordance with the present invention, the use of ionic liquids opens up the possibility to improve and extend the options open to the tanner.

Fatliquoring is a process by which lubricating oils are returned to a leather following tanning. This increases flexibility and softness of the finished leather. Traditionally the oils are added as aqueous, self-emulsifying formulations or microemulsions and the solubility of the oil in the water is limited. This limits the mechanism by which the leather can be impregnated and the targeting of deposition down the hierarchy of the protein structure and also contributes to contamination of aqueous streams. In accordance with the present invention, the miscibility of plant oils and animal fats is increased when ionic liquids are used and these can increase the uptake of the oil into the leather structure.

A key advantage of using Eutectic mixtures in accordance with the present invention is that dyeing, retanning and fat liquoring can all be carried out using a Eutectic mixture of choline chloride and ethylene glycol (1:2 molar ratio) using almost any dye. Therefore the methods according to the present invention are not limited to water soluble dyes.

In one embodiment of the present invention, the pickling step is carried out using a Deep Eutectic solvent where the HBD is a carboxylic acid. For example, a Eutectic mixture of choline chloride and oxacilic acid.

The final step in leather production is finishing, in which resin, stabilisers and particulates are applied to the grain surface. Ionic liquids are particularly useful in this application due to their unusual solvent properties. The amphiphillic nature of ionic liquids makes them suitable for the dissolution of a wide range of solutes and the stabilisation of colloidal dispersions, beyond what is currently possible using aqueous systems.

### BRIEF DESCRIPTION OF THE FIGURES

FIG. 1 shows a photograph of the 10×10 cm samples of bovine hide pH 3.65 after tanning in 5 ionic liquids. From l to r 10×10 cm samples of bovine hide pH 3.65 tanned in (i) mimosa in ethaline, (ii) chestnut in ethaline, (iii) 1ChCl: 2 CrCl₃.6H₂O, (iv) 1CrCl₃.6H₂O: 2 urea, and (v) 1 KCr(SO₄)₂.10H₂O: 2 urea for 20 hours.

FIG. 2 shows samples of tanned leather impregnated with graphite (left from ethaline and right from water).

FIG. 3 shows: Above from left to right: 10×10 cm samples of bovine hide, pH 4, tanned in 1 ChCl: 2 CrCl₃6H₂O; 2 urea: 1 CrCl₃6H₂O; and 2 urea: 1 KCr(SO₄)₂.10H₂O for 18 hours. The samples below show the corresponding cross sections.

FIG. 4 shows: a) Above: From left to right: 10×10 cm samples of bovine hide, pH 4, tanned in mimosa in Ethaline, chestnut in Ethaline. Below: Corresponding cross sections. b) Mimosa tanning powder (middle) in water (left), and in Ethaline (right).

FIG. 5 shows: a) mass increase in leather soaking in Ethaline as a function of time and temperature, b) appearance of samples soaked in Ethaline at 70° C. for different times (hrs).

FIG. 6 shows: standard aqueous chromium-tanned bovine leather before (below), after (above) soaking in Ethaline containing 0.15 wt % Sudan Black B at 70° C. for 48 hours, (centre) water sample after washing leather for 15 minutes at 20° C. and (right) cross section of sample before and after dyeing.

FIG. 7 shows the changes in mechanical properties for the samples shown in FIG. 5 as a function of soaking time.

Certain embodiments of the invention are illustrated by way of the following examples.

### EXAMPLES

### Example 1

### Tanning/Retanning Using Ionic Liquids

This example demonstrates the applicability of different types of Deep Eutectic solvents to tanning.

Two different organic vegetable tanning agents (at a loading of 10 wt %) each in a eutectic mixture of choline chloride and ethylene glycol (1:2 molar ratio) were prepared:
chestnut, a hydrolysable polyphenol; and
mimosa, a condensed polyphenol, largely prorobinetinidin

Three chromium based Eutectic mixtures:
1 choline chloride: 2 CrCl₃.6H₂O
2 urea: 1 CrCl₃.6H₂O
2 urea: 1 KCr(SO₄)₂.10H₂O

To demonstrate the stabilisation of the hide collagen by chromium, the shrinkage temperature was determined by differential scanning calorimetry (DSC) using a heating rate of 5° C. min⁻¹. Raw hide was mixed with each of the tanning liquids for 5 hours before the samples were washed for 10 min with fresh water. Typical aqueous chromium tanning would normally be carried out over at least 10 hours.

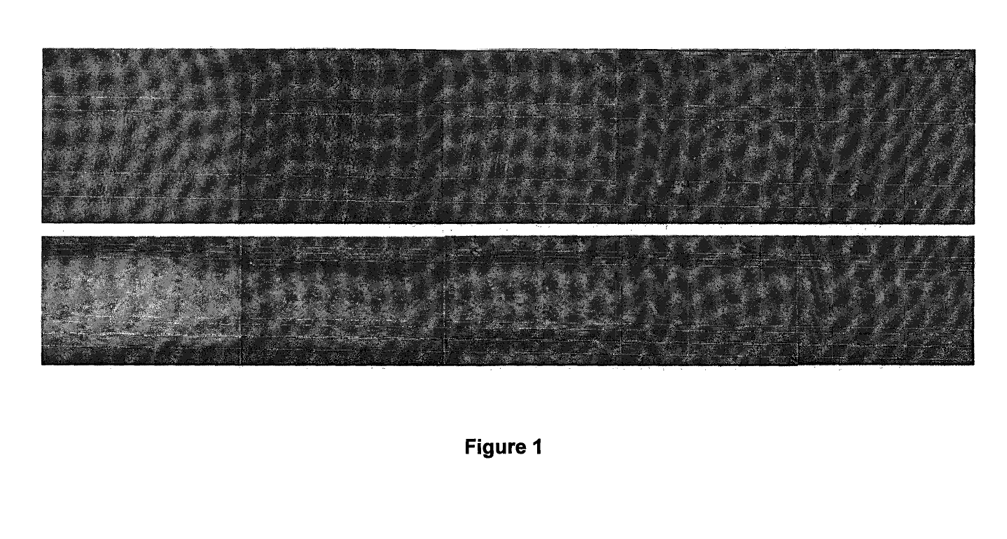

From FIG. 1, it can be seen that the tanning processes produce deeply coloured leather showing that the dyes bind to the hide in all cases. A mass balance of the liquid and hide showed that less than 5 wt % of liquid was lost during the process.

### Example 2

### Stabilising Graphite Dispersions in Ionic Liquids

This example demonstrates how graphite dispersions can be stabilised in a range of ionic liquids.

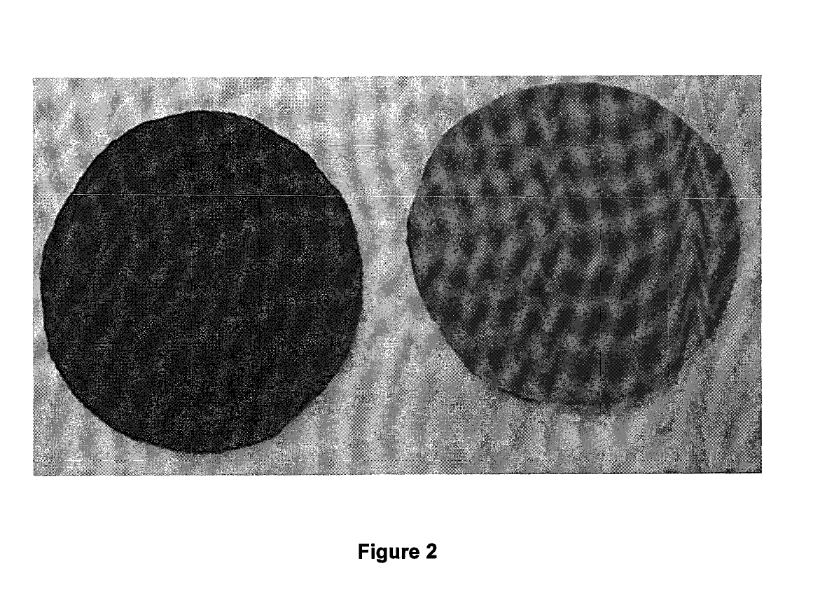

The graphite particles were firstly stirred into Eutectic mixtures of ethylene glycol and choline chloride. These Eutectic mixtures were then passed through a piece of blue crust leather which had previously been fat liquored. The particles were taken into the leather structure and even when the sample was washed with water most remained within the leather (FIG. 2). When the same experiment was repeated using water the graphite was totally washed out. A graphite impregnated leather could be useful due to its stabilising properties, its colour or it ability to conduct electricity.

### Example 3

### Chromium and Vegetable Tanning

The synthesis of the DESs was carried out using the method described in the literature (A. P. Abbott et al, Chem Commun, 70 (2003)). Samples of bovine hide were pre-treated and pickled according to a conventional leather manufacturing process. The final pH of the pickled hide was approximately 4. The bulk water was removed from the hide using a sammying machine and the final water content of the hide prior to tanning with Deep Eutectic Solvent (DES) was determined gravimetrically to be 62 wt %. Bovine hide samples (100 cm²) weighing 50±2 g were contacted with 23±2 g of DES for 18 hours at room temperature.

Following tanning, the excess DES was skimmed from the surface using a metal blade and the hide reweighed. The sample was then washed in cold water or 1 mol dm⁻³ sodium sulphate solution and allowed to air dry before being analysed by the techniques listed below. Negligible leaching of the DES from the hide into the water was observed during the washing stage. The Cr(III) reference sample was tanned according to a conventional aqueous recipe. Following the tanning trials the chromium content was determined, following the total digestion of the tanned leather samples, using an inductive coupled plasma-optical emission spectrometer (ICP-OES) according to the standard method BS EN ISO 5398-4:2007. The vegetable tanning was carried out in the same way as the chromium tanning using a eutectic mixture of choline chloride and ethylene glycol (1:2 molar ratio) at a loading of 10 wt % of either mimosa bark or chestnut wood.

For the dyeing experiments: 0.4 g of Sudan Black B was mixed with 200 ml of Ethaline 200 to make a 4.38×10⁻³ mol dm⁻³ dye solution. Samples of dried wet-blue leather (5 cm²) were fully submerged in the Ethaline 200 and Sudan Black B solution. The samples were then left in the solution at 70° C. for 24 hours. Once completed, the samples were washed for 15 minutes in deionised water, placed on absorbent paper and air-dried for a minimum of 24 hours at room temperature. The shrinkage temperature (Ts) was determined using differential scanning calorimetry (DSC) with 40 μL gold-lined high pressure pans with a heating rate of 5° C. min⁻¹ from 20 to 140° C. The measurement of the shrinkage temperature is important to determine the efficacy of a tanning agent to stabilise the collagen fibres and usually measured in a ‘wet state’. Samples were conditioned to 20° C. and 65% relative humidity according to BS EN ISO 3376:2011 and the tensile strength and elongation at break were determined using an lnstron tensiometer according to BS EN ISO 3376:2011.

### RESULTS

Chromium Tanning:

The applicability of three different types of DES solvents to tan hides was tested:
1 Choline chloride: 2 CrCl₃.6H₂O
2 Urea: 1 CrCl₃.6H₂O
2 Urea: 1 KCr(SO₄)₂.10H₂O

By creating highly concentrated Cr(III)-based liquids, it is possible to formulate a liquid-active ingredient. The aim is to liquefy the tanning agent through complexation to avoid the use of a solvent and thus minimise the total amount of material used. Any excess chromium salt can be mechanically removed and reused as it does not change the overall chemical composition since the leather absorbs both the anionic and cationic component of the liquid.

The majority of the costs with the tanning process is associated with the chromium salt and the recovery from dilute aqueous solutions after processing. Using DESs removes the solvent from the process and increases the efficiency of chromium salt uptake into the hide while minimising the treatment of aqueous effluent.

To demonstrate the uptake of chromium into the hide, the shrinkage temperature and chrome content was determined for samples of bovine hide treated with the three DESs listed above. Table 1 below shows the chromium content and shrinkage temperatures of the hide obtained from conventional Cr(III) tanning process using aqueous chromium (III) sulfate (33% basified, 25 wt % Cr₂O₃) with the three chromium-based DESs.

TABLE 1
Chromium content, shrinkage temperature and mechanical
properties of a bovine hide tanned with a conventional
process as well as DESs.

| | Leather | | | | |
|---|---|---|---|---|---|
| | Cr | | Thick- | Tensile | Elonga- |
| | content/ | Tₛ/ | ness/ | strength/ | tion/ |
| Tanning agent | % | ° C. | mm | MPa | % |
| Conventional aq. 33% | 3.04 | 109 | 3.02 | 32.6 | 50.8 |
| basic Cr(III) tanning | | | | | |
| salts | | | | | |
| 1 ChCl: | 2.27 | 71 | 2.55 | 37.7 | 39.3 |
| 2 CrCl₃•6H₂O | | | | | |
| 2 Urea: | 3.43 | 80 | 2.84 | 27.4 | 34.9 |
| 1 CrCl₃•6H₂O | | | | | |
| 2 Urea: | 3.52 | 83 | 3.10 | 30.3 | 42.5 |
| 1 KCr(SO₄)₂•10H₂O | | | | | |
| Mimosa extract | — | 83 | 2.92 | 56.6 | 50.5 |
| Chestnut extract | — | 78 | 2.62 | 43.2 | 65.7 |

It can be seen that all three DESs yield samples with a chromium content that is comparable with aqueous chromium tanning. The urea eutectics produce higher chromium content than the choline chloride based eutectics which is thought to be due to the charge on the chromium species. Both urea eutectics produce cationic chromium species whereas the choline chloride species is predominantly anionic. The hide samples increased in mass between 9 and 19%. Given that the chromium content of the 3 liquids is between 9 and 18% this corresponds approximately to the Cr content listed in Table 1. The data shows that both components of the DESs are absorbed into the collagen structure.

Despite the differences in speciation, the shrinkage temperatures for DES-treated samples are similar. The indicative shrinkage temperatures for hide tanned using DESs are however lower than conventional chrome tanning, although it should be noted that sulfate also plays a role in increasing the shrinkage temperature. The various chromium species diffuse rapidly into the hide samples but chemical binding may be slower than in aqueous solutions potentially due to the higher ionic strength of DESs. It should however be noted that no attempt has been made to optimise the process and fix the chromium in the DES-treated samples, whereas this is a requirement of the aqueous process. Fixing is generally achieved by raising the pH, increasing the temperature and/or with the addition of complexing agents.

Washing the sample treated with 1 ChCl: 2 CrCl₃.6H₂O with 1 mol dm⁻³ sodium sulphate solution increased the shrinkage temperature from 71 to 86° C. at pH 4 and this increased to 96° C. when the pH was increased to 8. This shows that the chromium can be fixed to the collagen structure irrespective of the anion in the DES solvent. In addition the shrinkage temperatures are comparable to those obtained using conventional chromium tanning solutions.

Table 1 also shows the strength and ductility of the tanned samples. The samples exhibited similar mechanical strength and elongation at break as the conventional aqueous Cr(III)-tanned leather, showing that the DES solvents have not exhibited deleterious effects on the mechanical properties of the hide.

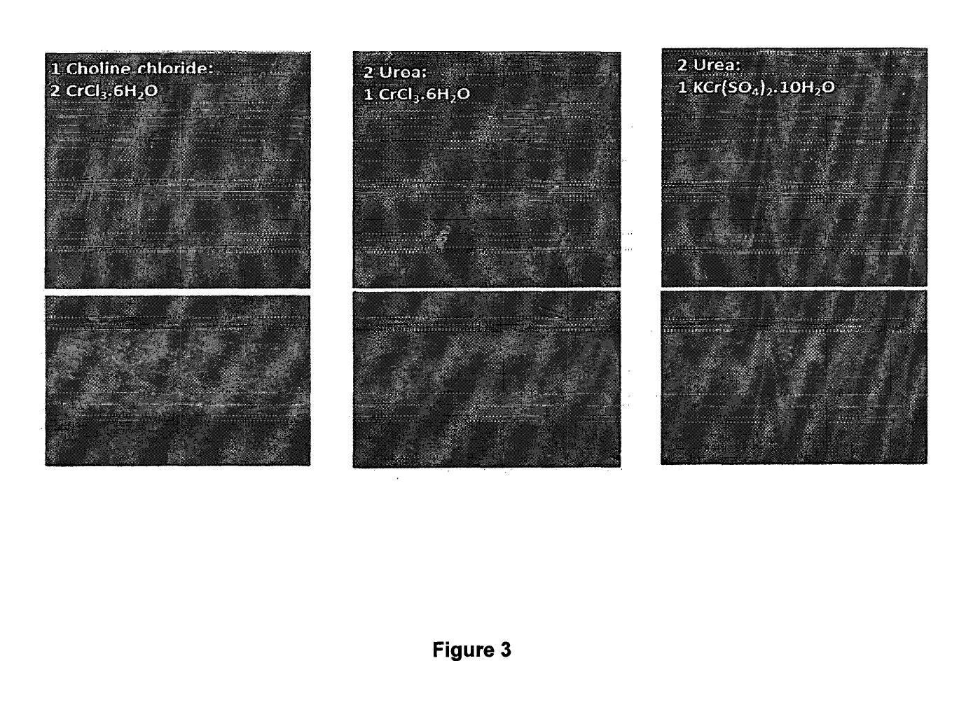

FIG. 3 shows the optical photographs and cross-sections of the Cr-DES samples listed in Table 1. It can be seen that all samples are intensely coloured by the tanning process. The cross-sectional images show that the tanning agent has penetrated through the material. Cross-sections taken during the tanning process showed that the urea-based liquids had permeated the hide rapidly suggesting that the treatment period utilised could be considerably optimised with the potential to be more rapid than the aqueous tanning methods. It should also be noted that the three chromium DES-tanned samples all exhibited various colours originating from different speciation.

Chromium salts are used for approximately 80-85% of tanned leather. From a “Green” perspective, the concern with chromium tanning of leather relates to the emission of large volumes of dilute aqueous chromium which has to be treated. The tanned leather will retain a variable amount of moisture which is integral to the stability of the collagen structure, making the calculation of Green-metrics quite complex since an exact mass balance is difficult to quantify. The conventional aqueous tanning process starts with an equal mass of aqueous Cr(III) salt solution so nominally the Sheldon E factor is >1 since the hides are subsequently treated with an aqueous base to fix the chromium to the collagen. The water, which is the major component by mass, is recycled and the remaining chromium content is usually recovered through a series of precipitation, adsorption or ion exchange processes. Notwithstanding, the wastewater may contain between 500 and 3000 ppm. Recovery of the chromium could bring the E factor down in the region of 0.002 to 0.005 for this stage.

DESs have the potential to decrease the total volume of chemical applied during the tanning process. The DESs are viscous and may be applied as a ‘cream’ to both sides of the hide similar to the ‘roller-coating’ process observed during the application of surface coatings to leather. Since both components of the DES are absorbed by the hide any liquid remaining can be physically squeezed from the hide and directly reused.

Vegetable Tanning

Chromium tanning is the technique used for the majority of leathers due to its relatively short tanning time, and high shrinkage temperature allowing the tanned leathers to be processed at higher temperature. Vegetable tanning agents form a smaller part of the market due primarily to the slow reaction kinetics and lower shrinkage temperatures. These tanning agents are potentially greener since the polyphenolic active ingredients are biodegradable and do not persist in the environment.

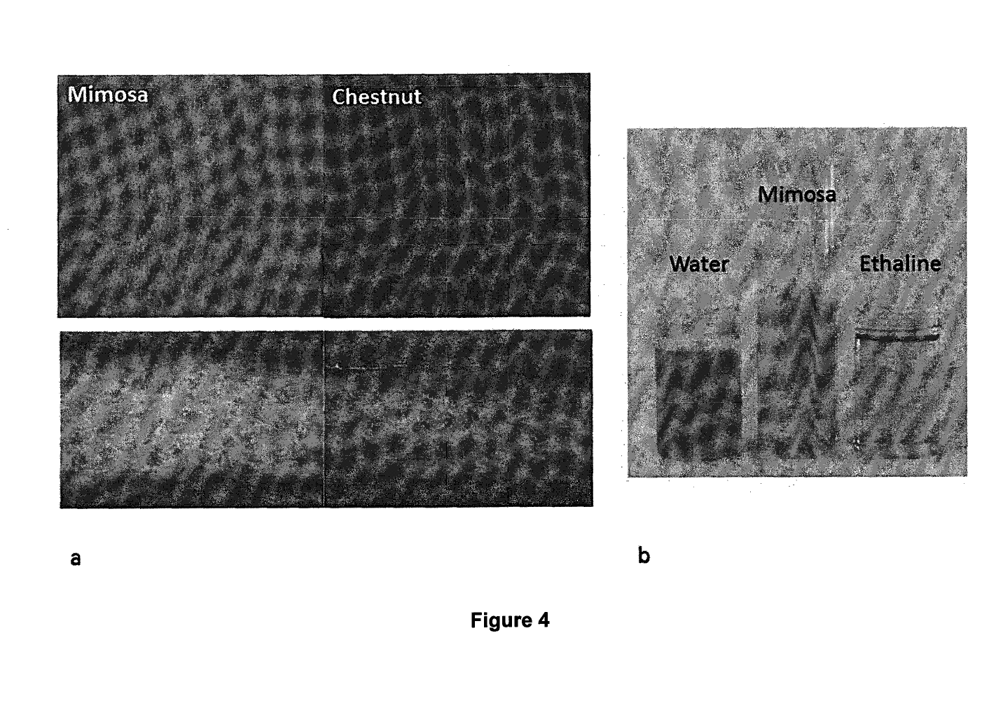

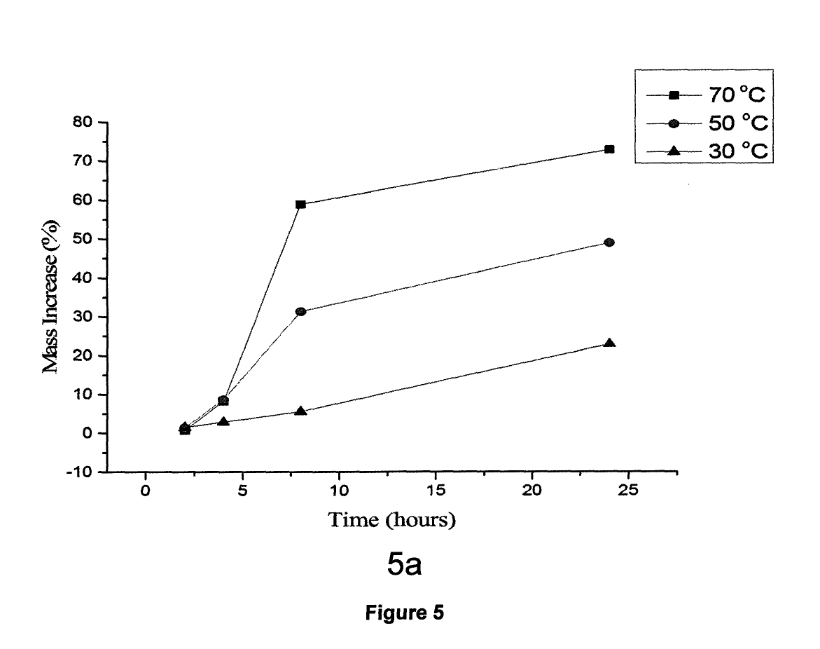

In addition to the three chromium-based tanning DESs shown above, two organic vegetable tanning agents chestnut wood (Castanea sativa) and mimosa bark (Acacia meamsii) were used, each in a eutectic mixture of choline chloride and ethylene glycol (1:2 molar ratio) at a loading of 10 wt %. The hide samples were treated as described previously. Data are shown in FIG. 4.

Vegetable tanning agents have poor solubility in water and are slow to solubilise. FIG. 4b shows the mimosa extract tanning solution in Ethaline, and for comparison sake, the comparable aqueous system. It can clearly be seen that the extract is considerably more soluble in Ethaline producing a more transparent solution. Vegetable tanning agents are polyphenolic compounds which tend to be poorly dispersed in aqueous solutions. They are used extensively in the retanning process prior to dyeing and fatliquoring. In the DESs, vegetable tannins form intensely coloured homogeneous solutions and this evidently aids their dispersal into the collagen structure. It is unsurprising that the vegetable tanning agents dissolve readily in DESs, as these solvent systems are good hydrogen bond donators as well as organic and relatively hydrophobic.

It is also evident from the cross sectional images in FIG. 4a that the fibrous structure of the leather is retained during the tanning process in ionic liquids.

Despite the differences in the chemical composition, the tanned leathers have similar properties. The mimosa-tanned sample exhibited the highest tensile strength, while chestnut showed a large strain at break (Table 1). Although the samples shown in FIG. 4 were undertaken for 18 hours for comparison sake with the samples shown in FIG. 3, considerably shorter tanning periods may possibly be used.

A partial volume of the ethylene glycol: choline chloride-DES in the vegetable tanning liquid, is retained in the collagen structure following washing with water and drying. Both vegetable tanned samples increased their mass by 19% showing that the DES becomes trapped within the collagen structure. This may act as a lubricating phase imparting greater flexibility to the dried leather. Since the DES liquid exhibits very low volatility, it will be retained within the tanned leather. The lubricating behaviour may be seen from the greater strain at break values for the vegetable-tanned samples. As discussed below, the trapped DES liquid may act as a lubricant that would normally be added during the post-tanning process. This is traditionally achieved using natural and synthetic fats and oils in a process known as “fatliquoring”.

A mass balance on the tanning process showed that the tanning liquid could be quantitatively recovered at the end of the process resulting in negligible waste. This is probably due to the low viscosity of these liquids compared with the chromium-based eutectics which tend to be a 100 times more viscous. Given that the liquid is not significantly depleted of tanning agent and so reused, this step of the tanning process has a Sheldon E factor of approximately zero.

Plasticising Leather

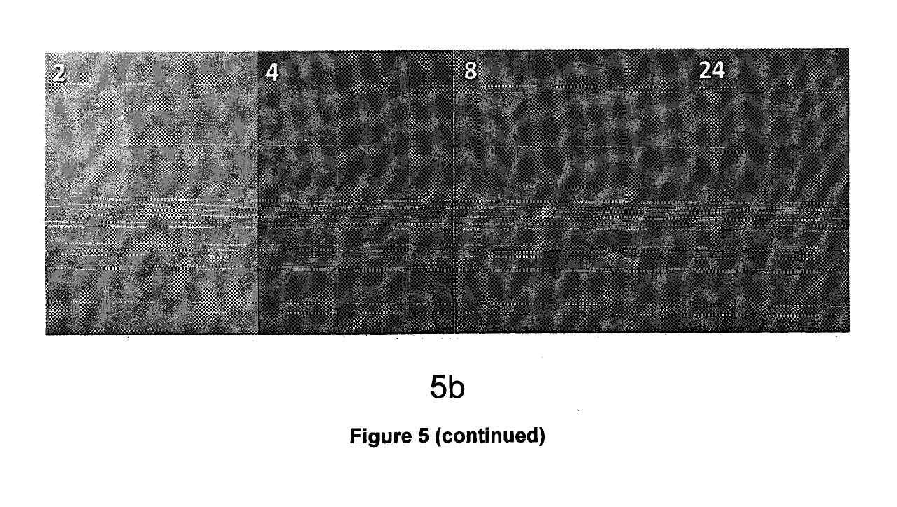

Once the tanning step is complete, the leather is usually plasticised with an oil in a process known as fatliquoring. The oils used are mostly from plant or fish origins, and are poorly miscible with water and lead to turbid waste solutions which are difficult to treat. Previous experiments from vegetable tanning showed that that the leather was flexible and soft and this is thought to originate from the DES trapped in the collagen structure. This could mean that the DES acts as an in-built fatliquor. A sample of aqueous chromium-tanned bovine leather was soaked in Ethaline at various temperatures and periods of time. The amount of Ethaline absorbed is shown in FIG. 5 as a function of time and temperature.

Following the soaking process, samples were washed in water and air dried. Interestingly the water content of the leather (determined by TGA) was lower than the untreated sample. A significant amount of DES could be absorbed into the leather e.g. at 70 ° C. for 24 hours the leather sample absorbed 73% by weight DES. It is evident from the appearance (FIG. 5b) that the structure of the leather can be changed by absorbing the DES.

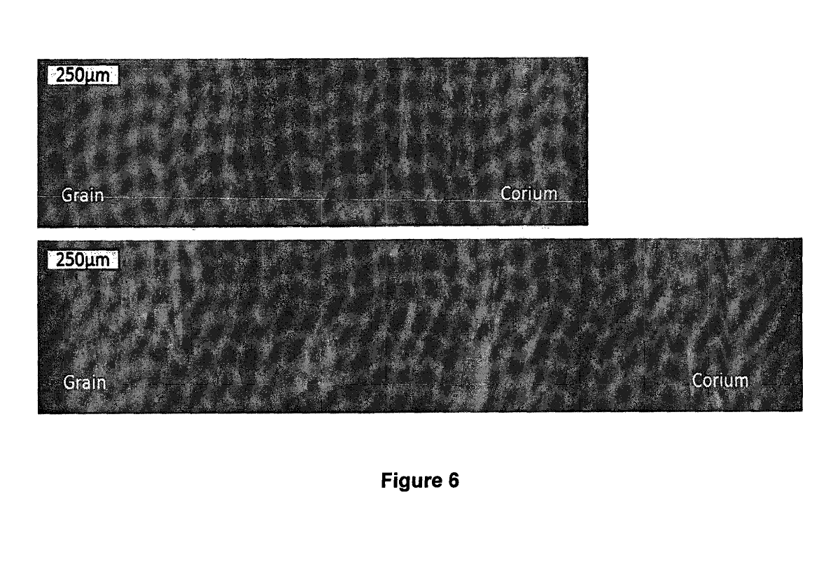

FIG. 6 shows the cross-sections of the leather before and after soaking in Ethaline. It is immediately apparent that the sample has swelled (56%). The swelling also appears to be homogeneous across the cross-section, with no change in the grain structure of the material. Furthermore, the DES does not leach from the sample and will not bleed when pressed with filter paper. It is therefore evident that the DES is bound to the collagen structure. This expansion of the collagen matrix appears to enable flexibility in the quaternary structure.

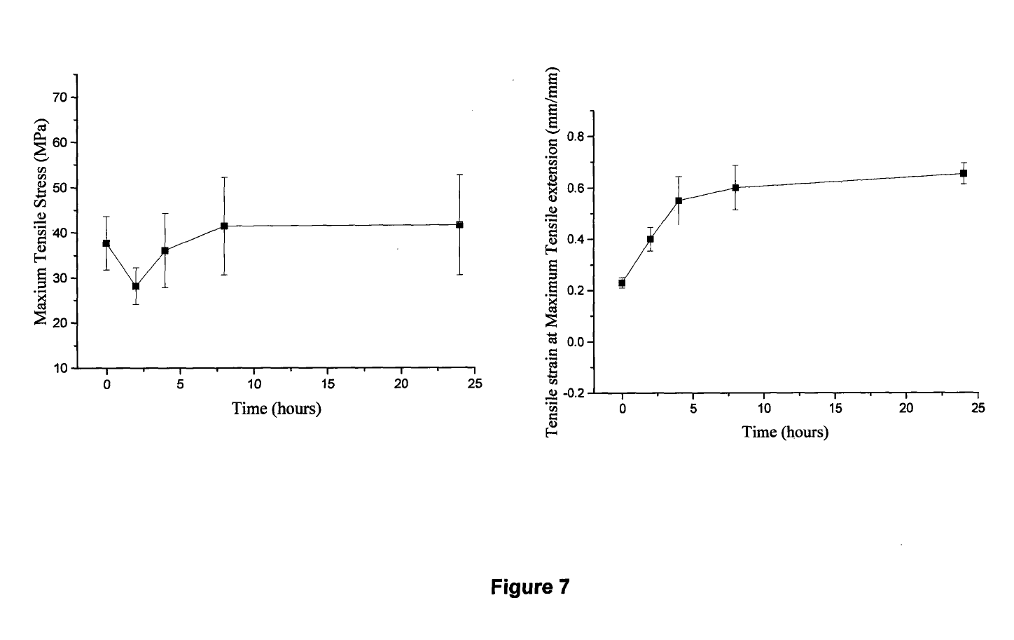

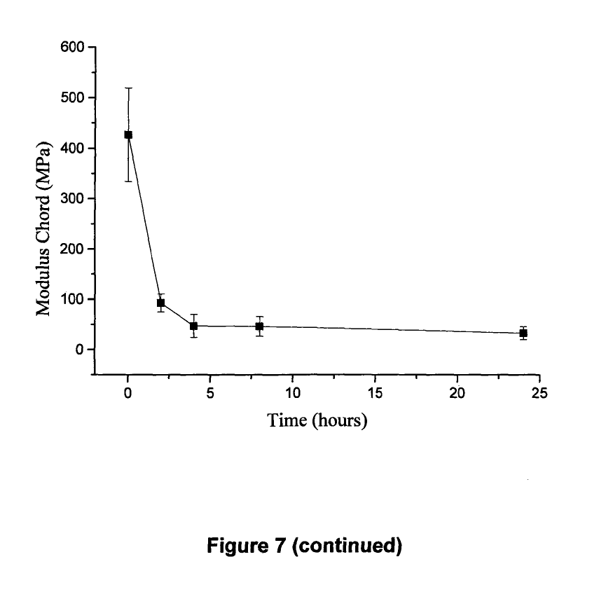

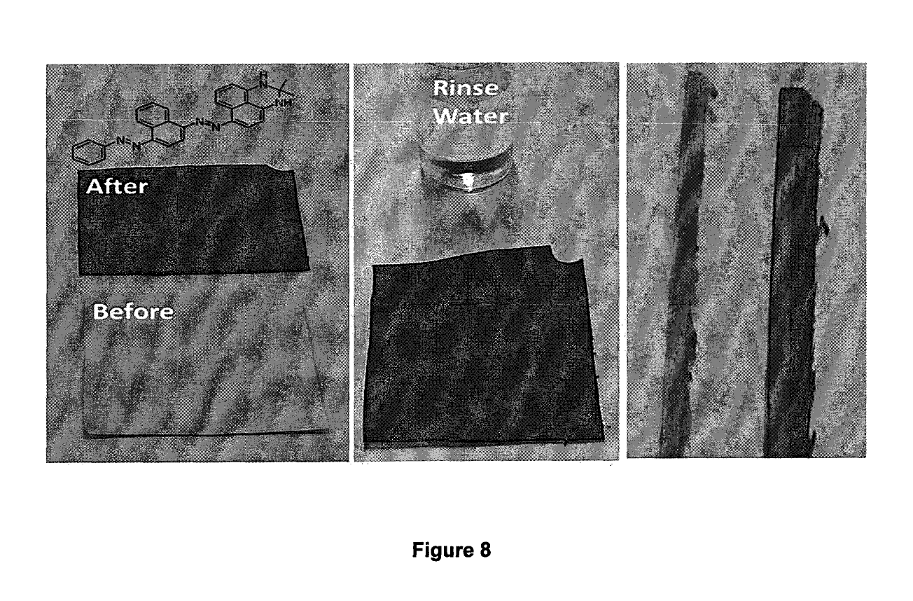

FIG. 7 shows the mechanical properties of the chrome-tanned leather that has been soaked in Ethaline for different periods of time. It is clear that the tensile strength is approximately constant and the tensile strain doubles when soaked. One of the largest changes is in the flexibility of the material which may be seen by the change in chordal modulus which decreases by approximately an order of magnitude when soaked for as little as 2 hours. While the results in FIGS. 3 and 4 show an extreme change in the properties of the leather they do show the potential to tune the properties of collagen using ionic fluids.

The amount of DES absorbed increased with time and temperature as would be expected, however the water content of the hide remained at about 12%, irrespective of the DES content compared to 18% in the untreated chromium tanned leather. This shows that the DES does not act as a hydrophilic additive as might be expected, instead the basicity of the anion is neutralised by interacting with hydrogen bond donators in the collagen structure.

Dyeing

Acid dyes are currently the most prevalent dye type in the leather industry due to the miscibility with water, and they can be fixed to collagen under acidic conditions. The colours available are wide ranging and exhibit good colour fastness. The molecules tend to be small and hydrophilic and generally anionic, binding electrostatically to protonated amino groups. The dyes also exhibit hydrogen bonding through auxochrome groups. Basic dyes are cationally charged and often more hydrophobic than the acid dyes with an affinity for anionic leather however, interaction also occurs via hydrogen bonding. Whilst they can produce vivid, bright colours they have poor colour fastness in comparison to acid dyes. A variety of dyes were solubilised in Ethaline including cationic dyes (Janus Black) and anionic dyes (Fast Black, Nuclear Fast Red and Polar Brilliant Red), however these dyes showed poor penetration into the leather and readily leached out when washed with water.

A non-ionic, lysochromic dye Sudan Black B (FIG. 8) was found to be soluble in DES and absorbed evenly throughout the leather. The dye produced an intense black shade which showed no evidence of leaching when the sample was washed in water. The dye penetrated throughout the cross-section of the leather (FIG. 8) showing that the DES has transformed the collagen into a more hydrophobic environment. In principle absorbing the dye and DES into the tanned leather as a gel should remove all waste water treatment from the post tanning process.

1. A process for tanning a substrate, comprising applying using at least one ionic liquid to the substrate.

2. The process of claim 1 wherein the substrate is selected from a collagenic biomaterial or a textile material.

3. The process of claim 2 wherein the collagenic biomaterial is selected from animal hides, skins, tendon, ligament and cartilage.

4. The process of claim 1 wherein the at least one ionic liquid is used in at least one of the following steps:
(i) tanning;
(ii) re-tanning;
(iii) preservation;
(iv) liming;
(v) pickling;
(vi) impregnation;
(vii) lubrication;
(viii) dyeing;
(ix) fatliquoring; or
(x) finishing.

5. The process of claim 4, wherein at least one of the steps further comprises using reagents which confer desired properties to the substrate and which are incorporated into the ionic liquids as solutes or as components of the ionic liquids themselves.

6. The process according to claim 5 wherein the reagents are selected from graphite, elemental sulphur, metal and semi-metal oxides, inorganic complexes and inorganic complex salts, organic polymers and reactive organic oligomers, Type II Eutectics and Type IV Eutectics.

7. The process of claim 4 wherein at least one of the steps is performed in a substantially non-aqueous system.

8. The process of claim 1 wherein the ionic liquid is in the form of a liquid formulation which is sprayed onto the substrate, preferably wherein the ionic liquid is in the form of a gel.

9. The process according to claim 4 wherein in the dyeing step, the ionic liquids are used to dissolve reactive dyes, preferably wherein the reactive dye is selected from dichlorotriazine or dichloroquinoxaline.

10. The process of claim 1 wherein the ionic liquid is selected from Deep Eutectic solvents, non-reactive ionic liquids with discrete anions and ionic liquids with Brönsted acidic cations.

11. The process of claim 10 wherein the Deep Eutectic solvent is selected from at least one of the following:
(i) metal salt+organic salt
(ii) metal salt hydrate+organic salt
(iii) organic salt+hydrogen bond donor
(iv) metal salt hydrate+hydrogen bond donor.

12. The process of claim 10 wherein the Deep Eutectic solvent is a mixture having a freezing point of up to 50° C., formed by reaction between:
(A) one molar equivalent of a salt of formula (I)
(Mⁿ⁺)(X⁻)ₙ (I)
or a hydrate thereof;
wherein
M represents one or more metallic elements selected from the group consisting of Mg, Ca, Cr, Mn, Fe, Co, Ni, Cu, Zn, Ga, Ge, In, Sn, Tl, Pb, Cd, Hg and Y,
X⁻ is one or more monovalent anions selected from the group consisting of halide, nitrate and acetate and
n represents 2 or 3; and
(B) from one to eight molar equivalents of a complexing agent comprising one or more uncharged organic compounds, each of which compounds has
(i) a hydrogen atom that is capable of forming a hydrogen bond with the anion X⁻; and
(ii) a heteroatom selected from the group consisting of O, S, N and P that is capable of forming a coordinative bond with the metal ion Mⁿ⁺,
which reaction is performed in the absence of extraneous solvent.

13. The process of claim 12 wherein the anion X⁻ is an anion selected from the group consisting of chloride, nitrate and acetate.

14. The process of claim 12 wherein the complexing agent (component (B)) consists of one or more organic compounds, each of which compounds has
(i) A hydrogen atom that is capable of forming a hydrogen bond with the anion X⁻; and
(ii) An oxygen atom that is capable of forming a co-ordinative bond with the metal ion Mⁿ⁺.

15. The process of claim 14 wherein the complexing agent consists of one or more compounds of formula II and/or formula III, 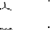
wherein
R¹ represents H, C₁₋₄ alkyl (which latter group is optionally substituted by one or more F atoms), or N(R²)R³;
R² and R³ independently represent H or C₁₋₄ alkyl (which latter group is optionally substituted by one or more F atoms);
A represents C₂₋₁₀ alkylene optionally
(i) substituted by one or more substituents selected from F, OH, SH and N(R⁴)R⁵, and/or
(ii) interrupted by one or more groups selected from O, S and NR⁶; and
R⁴ to R⁶ independently represent H or C₁₋₄ alkyl (which latter group is optionally substituted by one or more substituents selected from F and OH);
provided that the compound of formula (III) does not contain any C-atoms that are bonded to more than one atom selected from the group O, S and N.

16. The process of claim 14 wherein the complexing agent is acetamide, urea, ethylene glycol, 1,3-propanediol, 1,4-butanediol, 1,5-pentanediol, 1,6-hexanediol or glycerol.

17. The process of claim 11 wherein the Deep Eutectic solvent is a mixture is selected from:
(i) CrCl₃.6(H₂O)+2(urea); and
(ii) 1 Kr(SO₄)₂.10H₂O: 1 glycerol.

18. A leather or textile which is obtained using the process according to claim 1.

19. (canceled)

20. A method of making a leather, comprising applying at least one ionic liquid to a collagenic biomaterial.
